(19) United States
(12) Patent Application Publication
(10) Pub. No.: US 2019/0147269 A1
(43) Pub. Date: May 16, 2019

(54) INFORMATION PROCESSING APPARATUS, DRIVER MONITORING SYSTEM, INFORMATION PROCESSING METHOD AND COMPUTER-READABLE STORAGE MEDIUM

(71) Applicant: OMRON Corporation, Kyoto-shi (JP)

(72) Inventors: Hatsumi AOI, Kyotanabe-shi (JP); Tomoyoshi AIZAWA, Kyoto-shi (JP); Tadashi HYUGA, Hirakata-shi (JP); Yoshio MATSUURA, Kasugai-shi (JP); Masato TANAKA, Kizugawa-shi (JP); Keisuke YOKOTA, Kasugai-shi (JP); Hisashi SAITO, Kasugai-shi (JP)

(73) Assignee: OMRON Corporation, Kyoto-shi (JP)

(21) Appl. No.: 16/178,498

(22) Filed: Nov. 1, 2018

(30) Foreign Application Priority Data
Nov. 15, 2017 (JP) 2017-219769

(51) Int. Cl. G06K 9/00

(52) U.S. Cl. CPC G06K 9/00845; G06K 9/00228

(57) ABSTRACT

An information processing apparatus whereby the detection accuracy of a face direction of a driver of a vehicle can be improved, comprises an image acquiring part for acquiring an image including a face of a driver of a vehicle, a detecting part for detecting a face direction of the driver in the image acquired by the image acquiring part, an information acquiring part for acquiring information concerning a traveling condition of the vehicle, a first deciding part for deciding whether the vehicle is in a specified traveling condition based on the information acquired by the information acquiring part, and a reference determining part for determining a reference of the face direction of the driver based on the face direction of the driver while the vehicle is decided to be in the specified traveling condition by the first deciding part.

### BACKGROUND OF THE INVENTION

### 1. Field of the Invention

The present invention relates to an information processing apparatus, a driver monitoring system, an information processing method, and a computer-readable storage medium.

### 2. Description of the Relevant Art

In recent years, techniques of detecting the direction of a driver's face or visual line in a face image of the driver taken by a camera and deciding the driver state in vehicle traveling on the basis of the detected direction of the driver's face or visual line have been proposed.

In Patent Document 1, for example, a technique wherein the direction of a driver's visual line is detected on the basis of the center position of an eyeball and the center position of a pupil of the eye obtained in a face image of the driver taken by a camera, is disclosed. In Patent Document 2, a technique wherein the center line of a driver's face is determined using a face image of the driver taken by a camera, and on the basis of the distance from the center line to the outline position of the face, the degree of the face direction in the right-left direction when the front direction is set at 0° is detected, is disclosed.

In the techniques of detecting the direction of the driver's face or visual line disclosed in the above Patent Documents 1 and 2, with reference to the front direction previously selected on the device side, the direction of the diver's face or visual line is estimated. However, even when the driver is looking forward in the direction of travel of the vehicle, the direction of the driver's face, for example, the up-and-down direction, the right-and-left direction, or the degree of inclination to the left or right, differs among individuals. Even with regard to the same driver, the face direction thereof in the state of looking forward in the direction of travel of the vehicle sometimes varies according to the driving circumstances.

Since the differences among individuals in the face direction of the driver with respect to the front in the direction of travel of the vehicle are not taken into consideration in the conventional techniques disclosed in the above Patent Documents 1 and 2, the face direction of the driver cannot be accurately detected.

### PRIOR ART DOCUMENT

### Patent Document

Patent Document 1: Japanese Patent Application Laid-Open Publication No. 2007-68917

Patent Document 2: Japanese Patent Application Laid-Open Publication No. 2009-232945

### SUMMARY OF THE INVENTION

The present invention was developed in order to solve the above problem, and it is an object of the present invention to provide an information processing apparatus, a driver monitoring system, an information processing method, and a computer-readable storage medium, whereby the detection accuracy of a face direction of a driver of a vehicle can be improved.

In order to achieve the above object, an information processing apparatus according to a first aspect of the present invention is characterized by comprising:
an image acquiring part for acquiring an image including a face of a driver of a vehicle;
a detecting part for detecting a face direction of the driver in the image acquired by the image acquiring part;
an information acquiring part for acquiring information concerning a traveling condition of the vehicle;
a first deciding part for deciding whether the vehicle is in a specified traveling condition, on the basis of the information acquired by the information acquiring part; and
a reference determining part for determining a reference of the face direction of the driver, on the basis of the face direction of the driver while the vehicle is decided to be in the specified traveling condition by the first deciding part.

Using the information processing apparatus according to the first aspect of the present invention, whether the vehicle is in the specified traveling condition is decided by the first deciding part, and based on the face direction of the driver while the vehicle is decided to be in the specified traveling condition, the reference of the face direction for the driver is determined by the reference determining part. Consequently, it is possible to determine the reference according to the individual difference in the face direction of the driver, and using the reference, it becomes possible to improve the detection accuracy of the face direction of the driver.

The information processing apparatus according to a second aspect of the present invention is characterized by further comprising:
a second deciding part for deciding a change in the face direction of the driver while the vehicle is decided to be in the specified traveling condition by the first deciding part, wherein
the reference determining part determines the reference, on the basis of the face direction of the driver while the face direction of the driver is decided to remain unchanged by the second deciding part, in the information processing apparatus according to the first aspect of the present invention.

Using the information processing apparatus according to the second aspect of the present invention, based on the face direction of the driver while the vehicle is decided to be in the specified traveling condition and the face direction of the driver is decided to remain unchanged, the reference is determined. As a result, the accuracy of the reference can be enhanced.

The information processing apparatus according to a third aspect of the present invention is characterized by further comprising a calculating part for calculating the face direction of the driver with respect to the reference from the image, using the reference determined by the reference determining part, in the information processing apparatus according to the first or second aspect of the present invention.

Using the information processing apparatus according to the third aspect of the present invention, the face direction of the driver, for example, a difference from the reference can be calculated using the reference determined by the reference determining part, leading to an enhancement of the detection accuracy of the face direction of the driver.

The information processing apparatus according to a fourth aspect of the present invention is characterized by further comprising a processing part for conducting prescribed processing, on the basis of the face direction of the driver with respect to the reference calculated by the calculating part, in the information processing apparatus according to the third aspect of the present invention.

Using the information processing apparatus according to the fourth aspect of the present invention, it becomes possible to conduct prescribed processing by the processing part based on the face direction of the driver with respect to the reference calculated by the calculating part. The prescribed processing may be, for example, deciding the looking-aside of the driver, or deciding the consciousness state of the driver such as the degree of concentration or fatigue. Or it may be sending information concerning the face direction of the driver calculated by the calculating part to on-vehicle equipment.

The information processing apparatus according to a fifth aspect of the present invention is characterized by further comprising a notifying part for notifying the driver of a result processed by the processing part, in the information processing apparatus according to the fourth aspect of the present invention.

Using the information processing apparatus according to the fifth aspect of the present invention, it becomes possible to allow the notifying part to notify the driver of the result processed by the processing part.

The information processing apparatus according to a sixth aspect of the present invention is characterized by further comprising a reference storing part for storing the reference determined by the reference determining part, wherein
the calculating part calculates the face direction of the driver with respect to the reference from the image, using the reference read from the reference storing part, in the information processing apparatus according to any one of the third to fifth aspects of the present invention.

Using the information processing apparatus according to the sixth aspect of the present invention, the reference is read from the reference storing part and the face direction of the driver can be calculated using it. Consequently, it is possible to reduce the processing burden for determining the reference by the reference determining part.

The information processing apparatus according to a seventh aspect of the present invention is characterized by further comprising a reference changing part for changing the reference determined by the reference determining part, in the information processing apparatus according to any one of the third to sixth aspects of the present invention.

Using the information processing apparatus according to the seventh aspect of the present invention, it becomes possible to change the reference by the reference changing part. Consequently, the reference can be kept appropriate, and the face direction thereof can be continuously detected with high accuracy.

The information processing apparatus according to an eighth aspect of the present invention is characterized by the reference changing part, which corrects the reference so as to reduce a difference between the face direction of the driver with respect to the reference calculated by the calculating part and the reference, when the difference therebetween has been held within a prescribed range, in the information processing apparatus according to the seventh aspect of the present invention.

Using the information processing apparatus according to the eighth aspect of the present invention, even if the face direction of the driver is unconsciously changed little by little because of long-time driving or changes in driving circumstances, the reference can be appropriately corrected. Therefore, the face direction thereof can be continuously detected with high accuracy.

The information processing apparatus according to a ninth aspect of the present invention is characterized by the specified traveling condition, which is a traveling condition where the vehicle is going straight forward, in the information processing apparatus according to any one of the first to eighth aspects of the present invention.

Using the information processing apparatus according to the ninth aspect of the present invention, based on the face direction of the driver in the traveling condition where the vehicle is going straight forward, the reference is determined. Consequently, the face direction of the driver in a state where the driver is estimated to be looking in the straightforward direction of the vehicle, can be used as the reference.

The information processing apparatus according to a tenth aspect of the present invention is characterized by the information acquiring part, which acquires at least speed information of the vehicle and steering information of the vehicle, and
the first deciding part, which decides that the vehicle is in the specified traveling condition, when the speed of the vehicle is within a prescribed speed range and the vehicle is in a prescribed non-steering state, in the information processing apparatus according to any one of the first to eighth aspects of the present invention.

Using the information processing apparatus according to the tenth aspect of the present invention, when the speed of the vehicle is within the prescribed speed range and the vehicle is in the prescribed non-steering state, it is decided that the vehicle is in the specified traveling condition. Accordingly, based on the face direction of the driver in a state where the driver is estimated to be looking in the straightforward direction of the vehicle, the reference can be determined.

The information processing apparatus according to an eleventh aspect of the present invention is characterized by the information acquiring part, which acquires at least one of acceleration/deceleration information of the vehicle and inclination information of the vehicle, and
the first deciding part, which excepts a case where the vehicle is in a prescribed state of acceleration or deceleration, or a case where the vehicle is in a prescribed inclined position from the specified traveling condition, in the information processing apparatus according to any one of the first to eighth aspects of the present invention.

In the case where the vehicle is in the prescribed state of acceleration or deceleration, or in the case where the vehicle is in the prescribed inclined position, there are possibilities that the face of the driver might roll, leading to a change in the face direction thereof Using the information processing apparatus according to the eleventh aspect of the present invention, it is possible to prevent the reference from being determined under such circumstances.

The information processing apparatus according to a twelfth aspect of the present invention is characterized by the information acquiring part, which acquires position information of the vehicle and map information of the periphery of the vehicle, and
the first deciding part, which decides that the vehicle is in the specified traveling condition when the vehicle is moving on a straight-line road, in the information processing apparatus according to any one of the first to eighth aspects of the present invention.

Using the information processing apparatus according to the twelfth aspect of the present invention, when it is decided that the vehicle is moving on a straight-line road, based on the position information of the vehicle and the map information of the periphery of the vehicle, it is decided that the vehicle is in the specified traveling condition. Consequently, based on the face direction of the driver in a state where the driver is estimated to be looking in the straightforward direction of the vehicle, the reference can be determined.

The information processing apparatus according to a thirteenth aspect of the present invention is characterized by further comprising an identifying part for identifying the driver, wherein the reference determining part determines the reference for each driver identified by the identifying part, in the information processing apparatus according to any one of the first to twelfth aspects of the present invention.

Using the information processing apparatus according to the thirteenth aspect of the present invention, the driver is identified by the identifying part, and for each of the identified drivers, the reference can be determined. Therefore, even when another driver operates the vehicle, it becomes possible to detect the face direction of every driver with high accuracy.

A driver monitoring system according to the present invention is characterized by comprising the information processing apparatus according to any one of the first to thirteenth aspects of the present invention, and at least one camera for picking up an image including the face of the driver acquired by the image acquiring part.

Using the driver monitoring system, it is possible to realize at a low cost a driver monitoring system whereby effects of any one of the above information processing apparatuses can be obtained.

An information processing method according to the present invention is characterized by comprising the steps of:
acquiring an image including a face of a driver of a vehicle;
detecting a face direction of the driver in the image acquired in the image acquisition step;
acquiring information concerning a traveling condition of the vehicle;
deciding whether the vehicle is in a specified traveling condition, on the basis of the information acquired in the information acquisition step; and
determining a reference of the face direction of the driver, on the basis of the face direction of the driver while the vehicle is decided to be in the specified traveling condition in the decision step.

Using the information processing method, whether the vehicle is in the specified traveling condition is decided in the decision step, and based on the face direction of the driver while the vehicle is decided to be in the specified traveling condition, the reference of the face direction for the driver is determined in the reference determination step. Consequently, the reference can be determined in accordance with the individual difference in the face direction of the driver, and using the reference, it becomes possible to improve the detection accuracy of the face direction of the driver.

A computer-readable storage medium according to the present invention is characterized by the computer-readable storage medium in which computer programs have been stored, the programs for allowing at least one computer to conduct the steps of:
acquiring an image including a face of a driver of a vehicle;
detecting a face direction of the driver in the image acquired in the image acquisition step;
acquiring information concerning a traveling condition of the vehicle;
deciding whether the vehicle is in a specified traveling condition, on the basis of the information acquired in the information acquisition step; and
determining a reference of the face direction of the driver, on the basis of the face direction of the driver while the vehicle is decided to be in the specified traveling condition in the decision step.

Using the computer-readable storage medium, by allowing the at least one computer to read the programs and conduct each of the above steps, the reference according to the individual difference in the face direction of the driver can be determined. And using the reference, an information processing apparatus which can improve the detection accuracy of the face direction of the driver can be realized.

### BRIEF DESCRIPTION OF DRAWINGS

FIG. 1 is a diagrammatic illustration showing an example in which a driver monitoring system including an information processing apparatus according to an embodiment is applied to a vehicle.

FIG. 2 is a block diagram showing an example of a construction of an on-vehicle system having the driver monitoring system according to the embodiment.

FIG. 3 is a block diagram showing an example of a hardware construction of the information processing apparatus according to the embodiment.

FIG. 4 is a flowchart showing an example of processing operations of reference determination conducted by a control unit in the information processing apparatus according to the embodiment.

FIG. 5 is a flowchart showing an example of processing operations of face direction detection conducted by the control unit in the information processing apparatus according to the embodiment.

FIG. 6 is a flowchart showing an example of processing operations of monitoring conducted by the control unit in the information processing apparatus according to the embodiment.

FIG. 7 is a flowchart showing an example of processing operations of reference changing conducted by the control unit in the information processing apparatus according to the embodiment.

### DESCRIPTION OF THE EMBODIMENTS

The embodiments of the information processing apparatus, the driver monitoring system, the information processing method, and the computer-readable storage medium according to the present invention are described below by reference to the Figures.

### Application Example

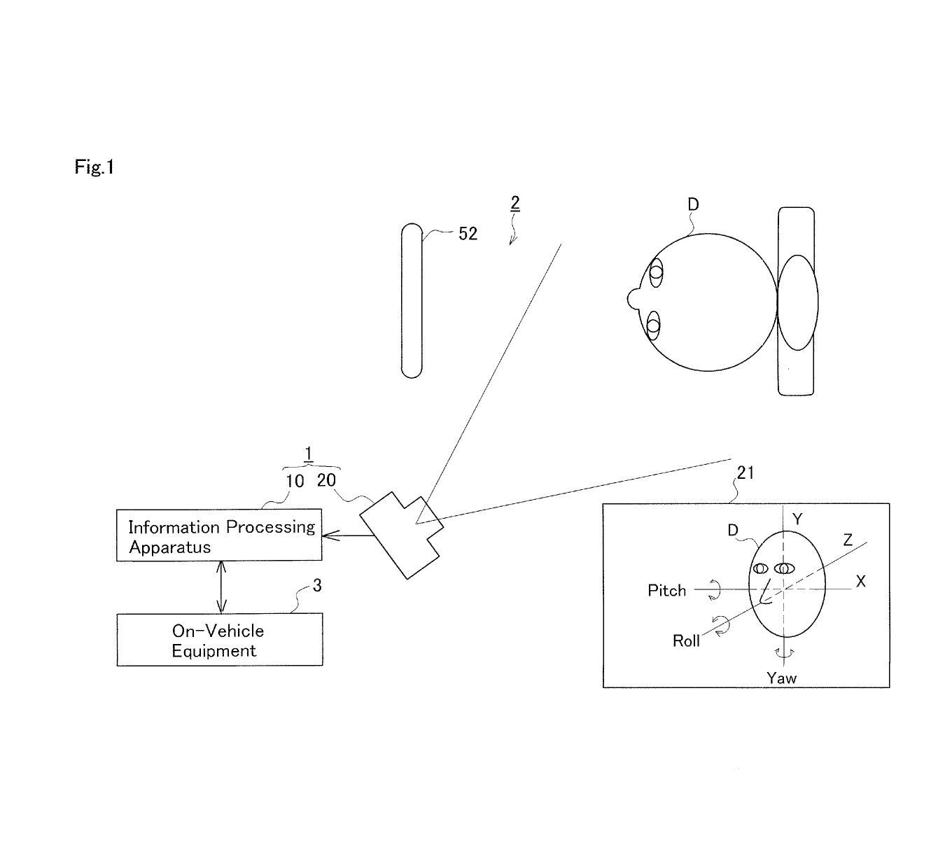

FIG. 1 is a diagrammatic illustration showing an example in which a driver monitoring system including an information processing apparatus according to an embodiment is applied to a vehicle.

A driver monitoring system 1 comprises an information processing apparatus 10 for conducting information processing for grasping the state of a diver D of a vehicle 2, and a camera 20 for picking up an image including a face of the driver D.

The information processing apparatus 10 is connected to on-vehicle equipment 3 mounted on the vehicle 2. It can acquire information of various kinds concerning a traveling condition of the vehicle 2 from the on-vehicle equipment 3, while it can output control signals and the like to the on-vehicle equipment 3. The information processing apparatus 10 is constructed by electrically connecting a control unit, a storage unit, an input-output interface and the like.

The on-vehicle equipment 3 may include, besides control devices of every kind for controlling a power source, a steering mechanism, a braking mechanism and the like of the vehicle 2, a presenting device for presenting information of every kind of the vehicle 2, a communication device for communicating with the outside of the vehicle 2, and various kinds of sensors for detecting the condition of the vehicle 2 or the situation of the outside of the vehicle 2. And the on-vehicle equipment 3 may be constructed in such a manner that each device can mutually communicate through an on-vehicle network such as CAN (Controller Area Network).

The control devices may include a driving support control device for automatically controlling one of the driving operations of acceleration/deceleration, steering and braking of the vehicle 2 to support the driving operations of the driver. Or the control devices may include an automatic operation control device for automatically controlling two or all of the driving operations of acceleration/deceleration, steering and braking of the vehicle 2. The presenting device may include a navigation device, a notifying device and a user interface of every kind. Or the information processing apparatus 10 may be incorporated into the on-vehicle equipment 3.

The camera 20 which is a device for imaging the driver D comprises, for example, a lens part, an imaging element part, a light irradiating part, an interface part, and a control part for controlling each of these parts, none of them shown. The imaging element part comprises an imaging element such as a CCD (Charge Coupled Device) or a CMOS (Complementary Metal Oxide Semiconductor), a filter, a microlens and the like. The imaging element part includes what can form a picked-up image with lights in the visible region, and may further include a CCD or a CMOS which can form a picked-up image with ultraviolet rays or infrared rays, or an infrared sensor such as a photodiode. The light irradiating part includes a light emitting element such as an LED (Light Emitting Diode), or in order to be able to photograph the driver state day and night, an infrared LED may be used. The control part comprises, for example, a CPU (Central Processing Unit), a memory and an image processing circuit. The control part controls the imaging element part and the light irradiating part so as to conduct the control in which light (e.g., near infrared rays) is irradiated from the light irradiating part and the reflected light thereof is picked up by the imaging element part. The camera 20 picks up an image at a prescribed frame rate (e.g., 30-60 frames/sec), and data of the image picked up by the camera 20 is output to the information processing apparatus 10.

One camera 20, or two or more cameras 20 may be used. The camera 20 may be constructed separately from the information processing apparatus 10 (as another cabinet), or may be integrated with the information processing apparatus 10 (in one cabinet). The camera 20 may be a monocular camera, or a stereo camera.

The mounting position of the camera 20 in the car room is not particularly limited, as far as the field of vision including at least the face of the driver D can be imaged from the position. For example, besides near the center of a dashboard of the vehicle 2, it may be mounted on a steering wheel portion, on a steering column portion, on a meter panel portion, in the vicinity of a room mirror, on an A pillar portion, or on a navigation device. And information including the specification (such as an angle of view and the number of pixels (length×width)) and the position posture (such as the mounting angle and distance from a prescribed origin point (e.g., a center position of the steering wheel)) of the camera 20 may be stored in the camera 20 or the information processing apparatus 10.

The information processing apparatus 10 conducts processing of grasping the face direction of the driver D as one of information processing for grasping the state of the driver D of the vehicle 2. And one of the characteristics of the information processing apparatus 10 is processing of determining a reference of the face direction of the driver D, which is used in processing of grasping the face direction of the driver D.

As mentioned in the section of Description of the Relevant Art, even when the driver is looking forward in the direction of travel of the vehicle, the face direction of the driver, for example, the up-and-down direction, right-and-left direction, or degree of inclination to the left or right, differs among individuals. Even in the case of the same driver, the face direction in looking forward in the direction of travel of the vehicle sometimes varies according to the driving circumstances.

Therefore, when conducting the processing of grasping the face direction of the driver, the information processing apparatus 10 determines a reference of the face direction for the driver D, in order that the face direction can be detected with high accuracy even if the face direction differs among individuals. The information processing apparatus 10 aims to enhance the detection accuracy of the face direction of the driver, using the reference of the face direction of the driver D.

Specifically, the information processing apparatus 10 acquires an image picked up by the camera 20, and detects the face direction of the driver in the acquired image. And the information processing apparatus 10 acquires information concerning a traveling condition of the vehicle 2 from the on-vehicle equipment 3, and decides whether the vehicle 2 is in a specified traveling condition.

The face direction of the driver D includes, for example, at least one of a pitch angle of the face of the driver D, which is an angle of rotation on the X axis (the lateral axis) (an upward and downward direction), a yaw angle of the face thereof, which is an angle of rotation on the Y axis (the vertical axis) (a right and left direction), and a roll angle of the face thereof, which is an angle of rotation on the Z axis (the longitudinal axis) (a right and left inclination), as shown in an image example 21.

The information concerning the traveling condition of the vehicle 2 includes, for example, speed information and steering information of the vehicle 2 acquired from the on-vehicle equipment 3. These pieces of information are examples of the below-mentioned “vehicle information”. The vehicle information may be data acquired from the on-vehicle equipment 3 connected through the CAN. And the specified traveling condition may be, for example, a traveling condition where the speed of the vehicle 2 is within a prescribed speed range and the vehicle 2 is in the state of non-steering, in other words, a traveling condition where the vehicle 2 is going straight forward.

On the basis of the face direction of the driver D while the vehicle 2 is decided to be in the specified traveling condition, the information processing apparatus 10 determines a reference of the face direction for the driver D. As a concrete example, the information processing apparatus 10 may decide a change in the face direction of the driver D while the vehicle 2 is in the specified traveling condition, and determine a reference of the face direction of the driver D, on the basis of the face direction of the driver D in a state where the face direction of the driver D is decided to remain unchanged.

As to the reference of the face direction, for example, at least one of the pitch angle, yaw angle, and roll angle which show the face direction of the driver detected in one or more images in the state where the vehicle 2 is decided to be in the specified traveling condition and the face direction of the driver D is decided to remain unchanged, or the mean value or the most frequent value thereof may be used as a value showing the reference (a reference value).

In this embodiment, the information processing apparatus 10 acquires an image of the driver D from the camera 20 and detects the face direction of the driver D in the acquired image, and also acquires information concerning a traveling condition of the vehicle 2 and based on the acquired information, decides whether the vehicle 2 is in a specified traveling condition.

Furthermore, the information processing apparatus 10 decides a change in the face direction of the driver in the state where the vehicle 2 is in the specified traveling condition, and determines a reference of the face direction of the driver based on the face direction of the driver while the face direction of the driver is decided to remain unchanged. Consequently, it is possible to determine the reference of the face direction according to the individual difference in the face direction of the driver D, and using the determined reference of the face direction, the detection accuracy of the face direction of the driver D can be enhanced without effects of differences among individuals in the face direction which is different depending on the driver.

In a general method of camera calibration conventionally conducted, by allowing a driver to gaze a given switch and the like, the position relationship between the switch and the driver is acquired, and using the acquired position relationship, the calibration is conducted. Therefore, the driver has to consciously conduct some operation or gaze, leading to labor and inconvenience. In this embodiment, however, since the reference of the face direction is determined without the driver's awareness, the ease of use can be improved.

### Construction Example

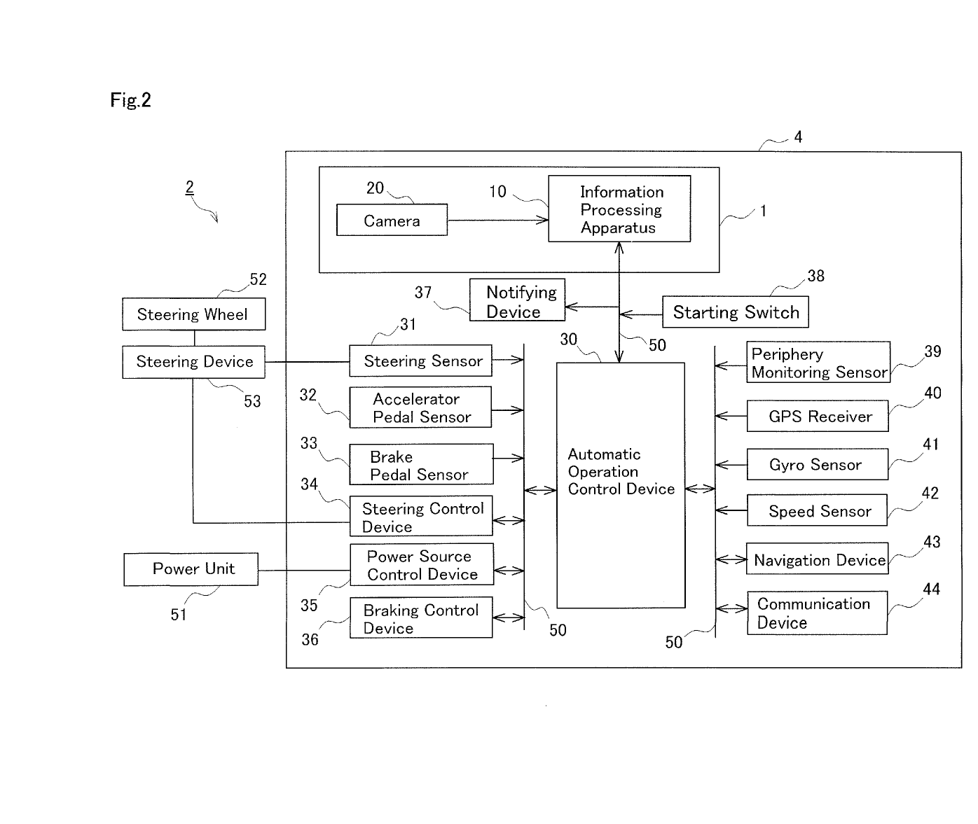

FIG. 2 is a block diagram showing an example of an on-vehicle system with the driver monitoring system according to the embodiment mounted thereon.

The on-vehicle system 4 comprises the driver monitoring system 1 and an automatic operation control device 30. The driver monitoring system 1 comprises the information processing apparatus 10 and the camera 20 as described above. The hardware construction of the information processing apparatus 10 is described below. In this embodiment, an example of application of an automatic operation system to the on-vehicle system 4 is described, but applicable systems are not limited to it.

The automatic operation control device 30 may have a construction of switching between an automatic operation mode in which at least part of or all of driving operations in traveling control including acceleration/deceleration, steering and braking of the vehicle 2 are automatically conducted mainly by the system and a manual operation mode in which a driver conducts the driving operations.

The automatic operation means, for example, that without the driver's driving operations, the vehicle 2 is automatically driven by control conducted by the automatic operation control device 30. The automatic operation may be at any one of the automation levels presented by the Society of Automotive Engineers, Inc. (SAE): Level 1 (driver assistance), Level 2 (partial automation), Level 3 (conditional automation), Level 4 (high automation), and Level 5 (full automation). The manual operation means that mainly the driver conducts driving operations to allow the vehicle 2 to travel.

The on-vehicle system 4 comprises, besides the driver monitoring system 1 and the automatic operation control device 30, sensors and control devices required for various kinds of control on the automatic operation and manual operation. It comprises, for example, a steering sensor 31, an accelerator pedal sensor 32, a brake pedal sensor 33, a steering control device 34, a power source control device 35, a braking control device 36, a notifying device 37, a starting switch 38, a periphery monitoring sensor 39, a GPS receiver 40, a gyro sensor 41, a speed sensor 42, a navigation device 43, and a communication device 44. These sensors and control devices of various kinds are electrically connected through a communication line 50.

The vehicle 2 has a power unit 51 which is a power source thereof such as an engine and a motor, and a steering device 53 having a steering wheel 52 for the driver's steering.

The automatic operation control device 30 is a device which conducts various kinds of control related to the automatic operation of the vehicle 2, consisting of an electronic control unit having a control part, a storing part, an input/output part and the like, none of them shown. The control part, comprising one or more hardware processors, reads programs stored in the storing part and conducts various kinds of vehicle control.

The automatic operation control device 30 is connected to, besides the information processing apparatus 10, the steering sensor 31, accelerator pedal sensor 32, brake pedal sensor 33, steering control device 34, power source control device 35, braking control device 36, periphery monitoring sensor 39, GPS (Global Positioning System) receiver 40, gyro sensor 41, speed sensor 42, navigation device 43, communication device 44 and the like. On the basis of information acquired from each of these devices, the automatic operation control device 30 outputs control signals for conducting automatic operation to each control device so as to conduct automatic operation control such as automatic steering, automatic speed regulation and automatic braking of the vehicle 2.

The automatic operation control device 30 may finish the automatic operation in cases where a previously selected condition was satisfied. The automatic operation control device 30 may finish the automatic operation, for example, when it is decided that the vehicle 2 in automatic operation reached a previously selected finish point of automatic operation and it is judged that the driver's attitude became an attitude which enables the driver to conduct manual operation. Or the automatic operation control device 30 may conduct control for finishing the automatic operation when the driver performed an automatic operation release operation (e.g., an operation of an automatic operation release button, the driver's operation of the steering wheel 52, accelerator or brake).

The steering sensor 31 is a sensor which detects a steering quantity to the steering wheel 52. It is located, for example, on a steering shaft of the vehicle 2, and detects a steering torque applied to the steering wheel 52 by the driver or a steering angle of the steering wheel 52. A signal according to an operation of the steering wheel by the driver detected by the steering sensor 31 is output to at least either the automatic operation control device 30 or the steering control device 34.

The accelerator pedal sensor 32 is a sensor which detects a stepping quantity of the accelerator pedal (the position of the accelerator pedal), and is located, for example, on the shaft portion of the accelerator pedal. A signal according to the stepping quantity of the accelerator pedal detected by the accelerator pedal sensor 32 is output to at least either the automatic operation control device 30 or the power source control device 35.

The brake pedal sensor 33 is a sensor which detects a stepping quantity of the brake pedal (the position of the brake pedal) or an operating force (such as a stepping force) thereof. A signal according to the stepping quantity or operating force of the brake pedal detected by the brake pedal sensor 33 is output to at least either the automatic operation control device 30 or the braking control device 36.

The steering control device 34 is an electronic control unit which controls the steering device (e.g., an electric power steering device) 53 of the vehicle 2. The steering control device 34 controls the steering torque of the vehicle 2 by driving the motor which controls the steering torque of the vehicle 2. In the automatic operation mode, the steering control device 34 controls the steering torque according to a control signal from the automatic operation control device 30.

The power source control device 35 is an electronic control unit which controls the power unit 51. The power source control device 35 controls the driving force of the vehicle 2, for example, by controlling the fuel supply and air supply to the engine, or the power supply to the motor. In the automatic operation mode, the power source control device 35 controls the driving force of the vehicle 2 according to a control signal from the automatic operation control device 30.

The braking control device 36 is an electronic control unit which controls the brake system of the vehicle 2. The braking control device 36 controls the braking force applied to the wheels of the vehicle 2, for example, by regulating the liquid pressure applied to a hydraulic brake system. In the automatic operation mode, the braking control device 36 controls the braking force to the wheels according to a control signal from the automatic operation control device 30.

The notifying device 37 is a device for conveying or announcing prescribed information to the driver. The notifying device 37 may comprise, for example, a voice output part which outputs announcements of every kind or an alarm by sound or voice, a display output part which displays announcements of every kind or an alarm by character or graphics, or allows a lamp to illuminate, or a vibration notification part which vibrates the driver's seat or steering wheel (none of them shown). The notifying device 37 works, for example, on the basis of a control signal output from the information processing apparatus 10 or the automatic operation control device 30.

The starting switch 38 is a switch for starting and stopping the power unit 51. It consists of an ignition switch for starting the engine, a power switch for starting the motor for traveling and the like. The operation signal of the starting switch 38 may be input to the information processing apparatus 10 or the automatic operation control device 30.

The periphery monitoring sensor 39 is a sensor which detects an object existing in the periphery of the vehicle 2. The object may include a moving object such as a car, a bicycle or a person, road surface signs (such as white lines), a guardrail, a medial strip, a structure which affects traveling of the vehicle, and the like. The periphery monitoring sensor 39 may include at least one selected from among a front monitoring camera, a rear monitoring camera, a Radar device, a device for LIDER, i.e., Light Detection and Ranging or Laser Imaging Detection and Ranging, and an ultrasonic sensor. The detection data of the object detected by the periphery monitoring sensor 39 is output to the automatic operation control device 30 and the like. As the front monitoring camera or rear monitoring camera, a stereo camera or a monocular camera can be adopted. The Radar device sends radio waves such as millimeter waves to the surroundings of the vehicle, and receives the radio waves reflected by the object existing in the surroundings of the vehicle, so as to detect the position, direction, distance and the like of the object. The LIDER device sends a laser light to the surroundings of the vehicle and receives the light reflected by the object existing in the surroundings of the vehicle, so as to detect the position, direction, distance and the like of the object.

The GPS receiver 40 is a device which receives a GPS signal from the artificial satellite through an antenna not shown, and conducts processing of calculating the position of one's own vehicle based on the received GPS signal (GPS navigation). The position information showing the one's own vehicle position calculated by the GPS receiver 40 is output to at least either the automatic operation control device 30 or the navigation device 43. The device for detecting the own position of the vehicle 2 is not limited to the GPS receiver 40. Besides the GPS, for example, devices adapted to quasi-zenith satellites of Japan, GLONASS of Russia, Galileo of Europe, Compass of China, or other navigation satellite systems may be applied.

The gyro sensor 41 is a sensor which detects the yaw rate of the vehicle 2. The yaw rate signal detected by the gyro sensor 41 is output to at least either the automatic operation control device 30 or the navigation device 43.

The speed sensor 42 is a sensor which detects the speed of the vehicle 2, consisting of, for example, a wheel speed sensor for detecting the rotation speed of a wheel thereof, installed on the wheel or a drive shaft thereof The speed information showing the speed detected by the speed sensor 42, for example, a pulse signal for calculating the speed is output to at least either the automatic operation control device 30 or the navigation device 43.

On the basis of the position information of the vehicle 2 measured by the GPS receiver 40 and map information in the map database (not shown), the navigation device 43 calculates the path and the lane on which the vehicle 2 travels, computes a route from the current position of the vehicle 2 to a destination and the like, displays the route on a display part (not shown), and conducts a voice output of route guidance and the like from a voice output part (not shown). The position information of the vehicle 2, information of the traveling path, and information of the planned traveling route, etc. obtained by the navigation device 43, may be output to the automatic operation control device 30. The information of the planned traveling route may include information related to switching control of automatic operation such as a start point and a finish point of an automatic operation section, or an advance start point and an advance finish point of automatic operation. The navigation device 43 comprises a control part, the display part, the voice output part, an operating part and a map data storing part, none of them shown.

The communication device 44 is a device which acquires information of every kind through a radio communication net, for example, a communication net such as a mobile phone net, VICS (Vehicle Information and Communication System) (a registered trademark), or DSRC (Dedicated Short Range Communications) (a registered trademark). The communication device 44 may have an inter-vehicle communication function or a road-vehicle communication function. For example, by the road-vehicle communication with a road side transmitter-receiver located on the side of the road, such as a light beacon or an ITS (Intelligent Transport Systems) spot (a registered trademark), road environment information (such as lane restriction information) of the path of the vehicle 2 may be acquired. Or by the inter-vehicle communication, information concerning other vehicles (such as position information, information of traveling control) or road environment information detected by the other vehicles may be acquired.

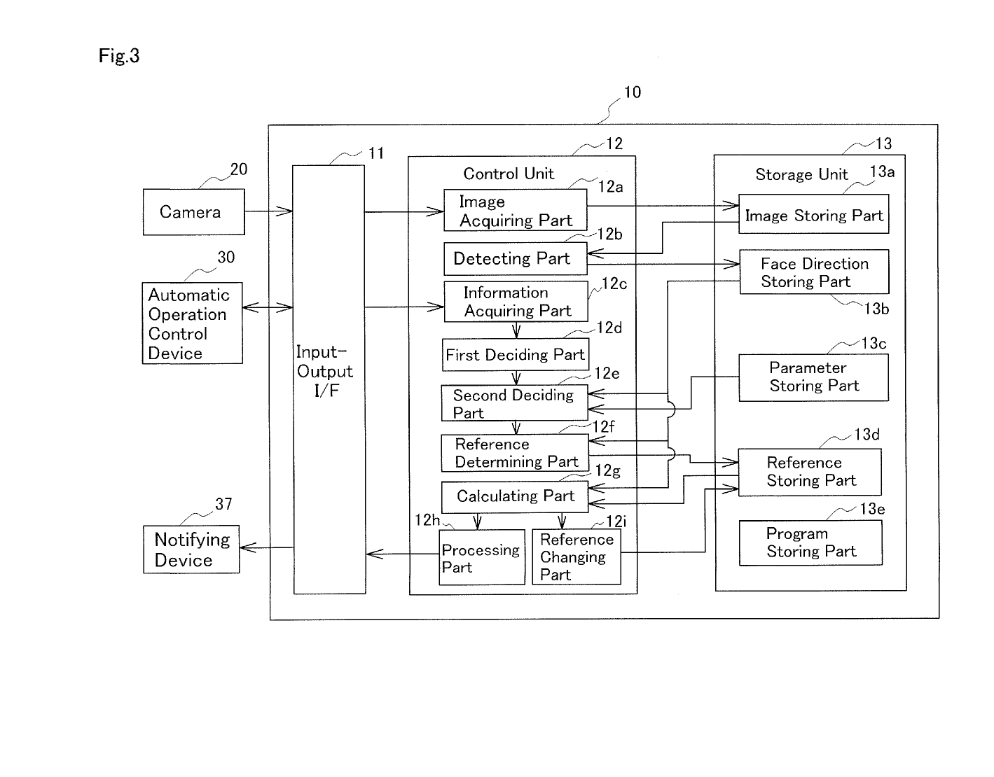

FIG. 3 is a block diagram showing an example of a hardware construction of the information processing apparatus 10 according to the embodiment.

The information processing apparatus 10 comprises an input-output interface (I/F) 11, a control unit 12, and a storage unit 13.

The input-output I/F 11 is connected to the camera 20, the automatic operation control device 30, the notifying device 37 and the like, comprising an interface circuit and a connector for giving and receiving signals to/from these external devices.

The control unit 12 comprises an image acquiring part 12a, a detecting part 12b, an information acquiring part 12c, a first deciding part 12d, a second deciding part 12e, and a reference determining part 12f. And it may further comprise a calculating part 12g, a processing part 12h, and a reference changing part 12i. The control unit 12 comprises one or more hardware processors such as a Central Processing Unit (CPU) or a Graphics processing unit (GPU).

The storage unit 13 comprises an image storing part 13a, a face direction storing part 13b, a parameter storing part 13c, a reference storing part 13d, and a program storing part 13e. The storage unit 13 consists of one or more storage devices which can store data using semiconductor elements, such as a Random Access Memory (RAM), a Read Only Memory (ROM), a Hard Disk Drive (HDD), a Solid State Drive (SSD), a flash memory, or other non-volatile memories or volatile memories. It may be constructed with the RAM and the ROM included in the control unit 12.

In the image storing part 13a, an image of a driver acquired from the camera 20 by the image acquiring part 12a is stored. In the face direction storing part 13b, information concerning the face direction of the driver in each image detected by the detecting part 12b is associated with each image stored in the image storing part 13a and stored. In the parameter storing part 13c, various kinds of parameters, such as a threshold of face direction, which are used in the decision by the second deciding part 12e, have been stored. In the reference storing part 13d, information concerning the reference of the face direction of the driver determined by the reference determining part 12f, such as a value representing the reference (a reference value), is stored. In the program storing part 13e, information processing programs conducted in each part of the control unit 12 and data required to conduct the programs have been stored.

The control unit 12 stores various kinds of data in the storage unit 13. And the control unit 12 reads various kinds of data and various kinds of programs stored in the storage unit 13, and carries out these programs. By cooperation of the control unit 12 with the storage unit 13, the operations of the image acquiring part 12a, detecting part 12b, information acquiring part 12c, first deciding part 12d, second deciding part 12e, and reference determining part 12f, and furthermore, the operations of the calculating part 12g, processing part 12h, and reference changing part 12i are implemented.

The image acquiring part 12a acquires an image of a driver picked up at a prescribed frame rate from the camera 20, and stores the image acquired from the camera 20 in the image storing part 13a.

The detecting part 12b reads every frame of the images stored in the image storing part 13a or each frame at established intervals, detects the face direction of the driver in the image, and associates to store the information concerning the detected face direction of the driver with the image concerned in the face direction storing part 13b.

The information concerning the face direction of the driver may include information of an angle showing the face direction of the driver detected by image processing, such as at least one of the above-mentioned yaw angle, pitch angle and roll angle. Or the information concerning the face direction of the driver may include information concerning the position of each organ of a face such as eyes, a nose, a mouth and eyebrows, for example, information concerning feature points showing the typical or characteristic position of each organ of the face.

The information acquiring part 12c acquires information concerning a traveling condition of the vehicle 2 through the automatic operation control device 30, and outputs the acquired information to the first deciding part 12d. The order of the processing of the information acquiring part 12c and the processing of the image acquiring part 12a may be inverted, or these operations may be conducted simultaneously. The information acquiring part 12c may acquire the information from each part of the on-vehicle system 4, not through the automatic operation control device 30.

In the information concerning the traveling condition, at least speed information of the vehicle 2 and steering information thereof are included. The speed information includes the speed information detected by the speed sensor 42 and the like. The steering information includes the steering angle or the steering torque detected by the steering sensor 31, or the yaw rate detected by the gyro sensor 41 and the like.

The information acquiring part 12c may acquire acceleration/deceleration information of the vehicle 2 or inclination information thereof The acceleration/deceleration information includes, for example, information of the stepping quantity of the pedal detected by the accelerator pedal sensor 32 or the brake pedal sensor 33, a driving control signal output from the power source control device 35, or a braking control signal output from the braking control device 36. The inclination information of the vehicle 2 includes inclination information detected by an inclination sensor (not shown) mounted on the vehicle 2, or inclination information of the road on which the own vehicle position calculated by the navigation device 43 exists.

The information acquiring part 12c may acquire position information of the vehicle 2 and map information of the periphery of the vehicle 2. In these pieces of information, for example, the own vehicle position calculated by the navigation device 43 and map information of the periphery of the own vehicle position are included.

Furthermore, the information acquiring part 12c may acquire information concerning an object to be monitored such as another vehicle or a person existing in the periphery of the vehicle 2, particularly in the direction of travel thereof In these pieces of information, for example, information concerning the kind of the object and the distance thereto, detected by the periphery monitoring sensor 39, is included.

The first deciding part 12d decides, on the basis of the information concerning the traveling condition acquired by the information acquiring part 12c, whether the vehicle 2 is in a specified traveling condition, and outputs the decision result to the second deciding part 12e. The specified traveling condition includes a traveling condition where the change in the face direction of the driver is small, that is, it is estimated that the face attitude thereof is stable, for example, a traveling condition where the vehicle 2 is going straight forward.

More specifically, the case where the vehicle 2 is in the specified traveling condition includes a case where the speed of the vehicle 2 is within a prescribed speed range and the vehicle 2 is in the state of non-steering. The state of non-steering indicates a state where steering of the steering wheel 52 is not substantially conducted. For example, there is a case where the steering angle detected by the steering sensor 31 is within a small range in the vicinity of 0°, or a case where the steering torque is within a small range in the vicinity of 0N·m. And the prescribed speed range is not particularly limited, but preferably an intermediate speed (40 km/h) or faster. That is because in the case of a low speed, a situation where the face attitude of the driver is not stable, such as a short distance from the vehicle ahead or a narrow path is supposed.

The first deciding part 12d may decide that the vehicle 2 is in the specified traveling condition when the vehicle 2 is moving on a straight-line road, based on the position information of the vehicle 2 and the map information of the periphery of the vehicle 2. The straight-line road is, for example, a flat straight-line road. Whether it is flat may be decided based on the slope information of the road included in the map information.

The first deciding part 12d may except a case where the vehicle 2 is in a prescribed state of acceleration or deceleration, or a case where the vehicle 2 is in a prescribed inclined position from the specified traveling condition. The prescribed state of acceleration or deceleration includes a state of sudden acceleration or sudden deceleration. The prescribed inclined position includes the inclined position when traveling on a slope having a given incline or more. The reason why these cases are excepted from the specified traveling condition is because a situation where the face attitude of the driver is not stable, so that the face direction thereof easily changes, is supposed.

The first deciding part 12d may decide that the vehicle 2 is not in the specified traveling condition when the distance from another vehicle detected by the periphery monitoring sensor 39 is not more than a prescribed value which shows that the distance between two vehicles is short. That is because a situation where the face attitude of the driver is not stable is supposed in a state of a short distance between two vehicles.

The second deciding part 12e decides a change in the face direction of the driver in the specified traveling condition decided by the first deciding part 12d, and outputs the decision result to the reference determining part 12f. For example, it decides whether it can be estimated that there is no change in the face direction of the driver. Specifically, it may read information of the face direction of the driver corresponding to the image concerned from the face direction storing part 13b, and decide whether the read face direction of the driver is within a prescribed range (e.g., a range of being regarded as the front with respect to the direction of travel of the vehicle) and the difference from the face direction of the driver in the immediately preceding image is below a prescribed threshold (within a range where the face direction can be estimated to remain unchanged). Parameters required for the decision such as the prescribed range and the prescribed threshold are read from the parameter storing part 13c.

The reference determining part 12f determines the reference of the face direction of the driver, based on the face direction of the driver while the face direction of the driver is decided to remain unchanged, and stores information concerning the determined reference of the face direction thereof in the reference storing part 13d.

Specifically, whether the state where the face direction of the driver can be estimated to remain unchanged decided by the second deciding part 12e, has continued for a prescribed period of time or longer is decided. That is, whether the decision result indicating the state where the face direction of the driver can be estimated to remain unchanged (i.e., the decision result of every image) was acquired consecutively for the prescribed period of time or longer (a prescribed number of frames may be adopted) is decided.

When it is decided that it was acquired consecutively for the prescribed period of time or longer, the information of the face directions of the driver corresponding to the images acquired in the prescribed period of time is read from the face direction storing part 13b, and using the read information of the face directions of the driver, the reference value is determined.

The reference value representing the reference of the face direction of the driver may be the mean value or the most frequent value of angle information showing the face direction of the driver, for example, at least one of the above-mentioned yaw angle, pitch angle and roll angle. Or it may include the mean value or the most frequent value of the feature point position showing the position of each organ of the face.

The above detecting part 12b, information acquiring part 12c, first deciding part 12d, second deciding part 12e, reference determining part 12f, and face direction storing part 13b conduct processing of determining the reference of the face direction of the driver in cooperation. On the other hand, the calculating part 12g, processing part 12h, and reference storing part 13d conduct processing of grasping (monitoring) the state of the driver in cooperation.

The calculating part 12g reads the reference of the face direction determined by the reference determining part 12f from the reference storing part 13d. Using the reference of the face direction, it calculates the face direction of the driver with respect to the reference of the face direction (e.g., a deviation from the reference value) from the image acquired by the image acquiring part 12a, and outputs the calculation result to the processing part 12h.

The processing part 12h conducts prescribed processing based on the face direction of the driver with respect to the reference of the face direction (e.g., the deviation from the reference value) calculated by the calculating part 12g. The prescribed processing may be, for example, processing wherein whether the driver is in the looking-aside state is decided, and in the case of the looking-aside state (e.g., in a case where the face direction in the right-left direction is deviated from the reference value by a given value or more), it instructs the notifying device 37 to conduct notification, or processing wherein the information of the face direction in the looking-aside state is stored in the storage unit 13 or output to the automatic operation control device 30 without notification.

Or the processing part 12h may decide the degree of concentration or fatigue (including sleepiness, etc.), and in the case of a reduced degree of concentration or a high degree of fatigue (e.g., in a case where the face direction in the downward direction is deviated from the reference value by a given value or more), instruct the notifying device 37 to conduct notification. Or the processing part 12h may store the information of the face direction in the state of the reduced degree of concentration or high degree of fatigue in the storage unit 13 in place of notification, or with notification. Or the processing part 12h may store the information of the face direction calculated by the calculating part 12g in the storage unit 13 without deciding the looking-aside state.

Or the prescribed processing may be processing wherein, in switching from an automatic operation mode to a manual operation mode, whether the driver is in a state of being able to deal with the transfer to manual operation is decided, and when it is decided that the driver can deal with the transfer (e.g., when the deviation of the face direction from the reference value is within a prescribed range suitable for manual operation), a signal which permits the switching to manual operation is output to the automatic operation control device 30.

The reference changing part 12i changes the reference of the face direction determined by the reference determining part 12f, for example, the reference value thereof, and stores the changed reference value in the reference storing part 13d. For example, in the case of a specified traveling condition (e.g., a straightforward traveling condition), when a situation where the difference between the face direction of the driver calculated by the calculating part 12g and the reference of the face direction is within a prescribed range (e.g., a situation where the face direction is deviated from the reference value in a fixed direction, but not to the extent of looking-aside) has continued for a fixed period of time or intermittently, the reference of the face direction may be changed, for example, corrected so as to reduce the difference therebetween. The processing conducted by the reference changing part 12i includes changing of the reference of the face direction in changing of driver.

### Operation Example

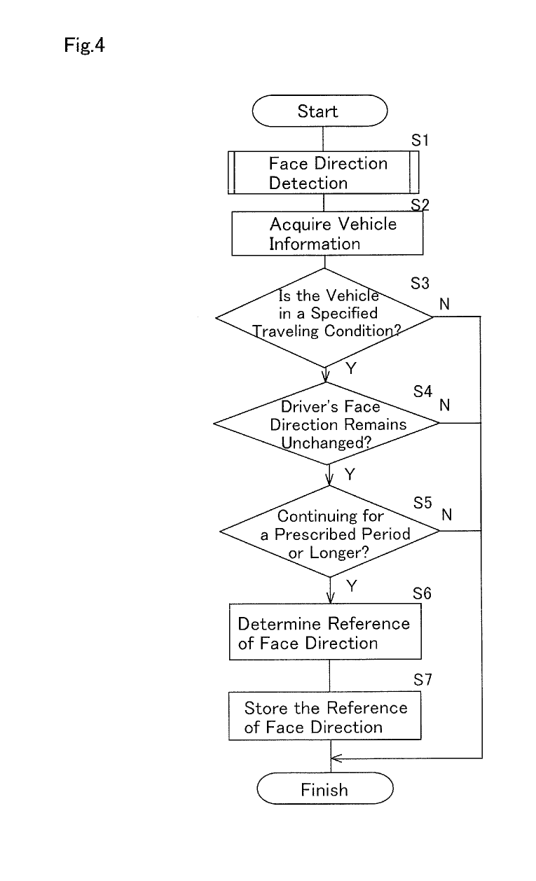

FIG. 4 is a flowchart showing an example of processing operations of reference determination conducted by the control unit 12 in the information processing apparatus 10 according to the embodiment. These processing operations may be conducted, for example, only for a fixed period of time after the starting switch 38 of the vehicle 2 was turned ON, or continuously while the camera 20 is working.

In step S1, the control unit 12 detects a face direction of a driver. By the camera 20, a prescribed number of frames of images are picked up every second. The control unit 12 captures these picked-up images chronologically, and may conduct this processing on every frame or each frame at established intervals.

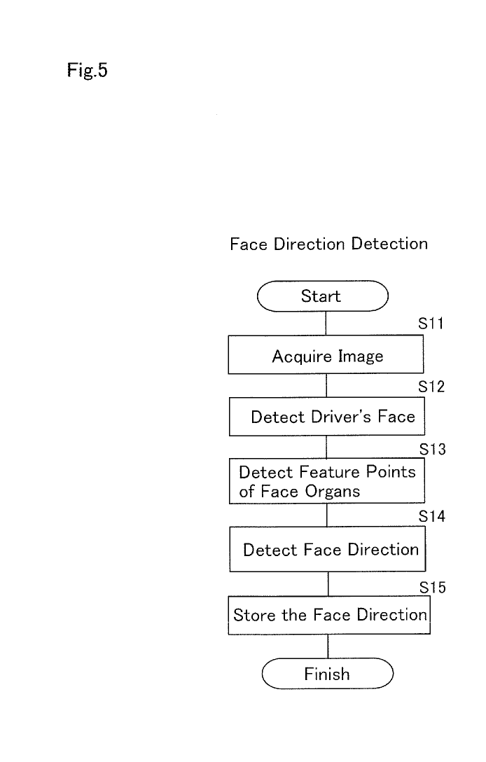

FIG. 5 is a flowchart showing an example of processing operations of the detection in step S1 conducted by the control unit 12. In step S11, the control unit 12 acquires an image picked up by the camera 20, and in step S12, the control unit 12 detects a face (e.g., a face area) of a driver in the acquired image. Then, the operation goes to step S13.

The method for detecting a face in an image conducted by the control unit 12 is not particularly limited, but a method for detecting a face at a high speed and with high precision is preferably adopted. For example, by regarding a contrast difference (a luminance difference) or edge intensity of local regions of the face, and the relevance (the cooccurrence) between these local regions as feature quantities, and using a hierarchical detector in which an identifying section roughly capturing the face is arranged at the first part of the hierarchical structure and an identifying section capturing the minute portions of the face is arranged at a deep part of the hierarchical structure, it becomes possible to search for the face area in the image at a high speed.

In step S13, the control unit 12 detects the positions and shapes of the face organs such as eyes, a nose, a mouth, and eyebrows in the face area detected in step S12. The method for detecting the face organs from the face area in the image is not particularly limited, but a method for detecting the face organs at a high speed and with high precision is preferably adopted. For example, a method wherein a three-dimensional face shape model is created, and fitted in a face area on a two-dimensional image, so as to detect the position and shape of each organ of the face can be adopted. The three-dimensional face shape model consists of nodes corresponding to feature points of each organ of the face. Using this method, it becomes possible to correctly detect the position and shape of each organ of the face, regardless of the mounting position of the camera 20 or the face direction in the image. As a technique of fitting a three-dimensional face shape model on a face of a person in an image, for example, the technique described in the Japanese Patent Application Laid-Open Publication No. 2007-249280 may be used, but it is not limited to this technique.

An example of fitting of a three-dimensional face shape model on a face of a driver in an image conducted by the control unit 12 is described below. In cases where a horizontal axis is represented by an X axis, a vertical axis is represented by a Y axis, and a depth (longitudinal) axis is represented by a Z axis when the face is viewed from the front, the three-dimensional face shape model has a plurality of parameters such as a rotation on the X axis (pitch), a rotation on the Y axis (yaw), a rotation on the Z axis (roll), and scaling. Using these parameters, it is possible to transform the shape of the three-dimensional face shape model.

By previously conducted error correlation learning, an error estimate matrix (conversion matrix) has been acquired. The error estimate matrix is a learning result about the correlation showing in which direction the position of the feature point of each organ of the three-dimensional face shape model located at an incorrect position (a different position from the position of the feature point of each organ to be detected) should be corrected, and a matrix for converting the feature quantity at the feature point to a change quantity of the parameter using multivariate regression.

On the basis of the detection result of the face, the control unit 12 initially places the three-dimensional face shape model at an appropriate position to the position, direction and size of the face. The position of each feature point at the initial position thereof is obtained, and a feature quantity at each feature point is calculated. The feature quantity at each feature point is input to the error estimate matrix, and a change quantity of a deformation parameter into the neighborhood of the correct position (an error estimate quantity) is obtained. To the deformation parameter of the three-dimensional face shape model at the current position, the error estimate quantity is added, so as to obtain an estimated value of the correct model parameter. Then, whether the obtained correct model parameter is within a normal range and the processing converged, is judged. When it is judged that the processing has not converged, the feature quantity of each feature point of a new three-dimensional face shape model created based on the obtained correct model parameter is obtained and the processing is repeated. On the other hand, when it is judged that the processing converged, the placement of the three-dimensional face shape model in the neighborhood of the correct position is completed. By these processing operations conducted by the control unit 12, the three-dimensional face shape model is fitted into the neighborhood of the correct position on the image at a high speed. And from the three-dimensional face shape model fitted in the correct position, the position and shape of each organ of the face are calculated.

In step S14, the control unit 12 detects the face direction of the driver based on the data of the position and shape of each organ of the face obtained in step S13. For example, at least one of the pitch angle of vertical rotation (on the X axis), yaw angle of horizontal rotation (on the Y axis), and roll angle of whole rotation (on the Z axis), included in the parameters of the three-dimensional face shape model placed in the neighborhood of the correct position, may be detected as information concerning the face direction of the driver.

In step S15, the control unit 12 associates to store the information concerning the face direction of the driver detected in step S14 with the image concerned in the face direction storing part 13b, and the processing is finished. The detection of the face direction is repeated on the next image.

In step S2 shown in FIG. 4, the control unit 12 acquires information concerning a traveling condition of the vehicle 2 (hereinafter, also referred to as the vehicle information). The order of the processing in step S1 and that in step S2 may be inverted. Or the processing in step S1 and that in step S2 may be conducted simultaneously.

The vehicle information includes, for example, at least speed information and steering information of the vehicle 2. And as the vehicle information, acceleration/deceleration information of the vehicle 2 or inclination information of the vehicle 2 may be acquired. And position information of the vehicle 2 or map information of the periphery of the vehicle 2 may be acquired. Furthermore, information concerning an object to be monitored such as another vehicle or a person existing in the periphery of the vehicle 2, particularly in the direction of travel thereof may be acquired. The vehicle information may be acquired through the automatic operation control device 30, or directly acquired from each part of the on-vehicle system 4.

In step S3, the control unit 12 decides whether the vehicle 2 is in a specified traveling condition based on the vehicle information acquired in step S2. The specified traveling condition includes, for example, a traveling condition in which the vehicle 2 is going straight forward.

In step S3, when the control unit 12 decides that the vehicle 2 is in the specified traveling condition, for example, when it decides that the speed of the vehicle 2 is within a prescribed speed range (e.g., an intermediate speed or faster) and that the vehicle 2 is in the state of non-steering (the state where it is not substantially steered) on the basis of the speed information and steering information of the vehicle 2, or when it decides that the vehicle 2 is moving on a straight-line road on the basis of the position information of the vehicle 2 and the map information of the periphery of the vehicle 2, the operation goes to step S4.

On the other hand, in step S3, when the control unit 12 decides that the vehicle 2 is not in the specified traveling condition, for example, when it decides that the speed of the vehicle 2 is not within the prescribed speed range (e.g., it is within a low speed range) or that the vehicle 2 is in the state of steering, when it decides that the vehicle 2 is in a state after sudden acceleration or sudden deceleration, when it decides that the vehicle 2 is running on a slope having a given incline or more, or when it decides that the distance from another vehicle decreased to a prescribed value or less, resulting in a short distance between two vehicles, the processing is finished.

In step S4, the control unit 12 decides a change in the direction of the face (or the head) of the driver while the vehicle 2 is in the specified traveling condition. For example, using the information of the face direction of the driver detected in step S1, whether the face direction of the driver can be estimated to remain unchanged is decided. Specifically, the information of the face direction of the driver corresponding to the image concerned is read from the face direction storing part 13b, and whether the read face direction of the driver is within a prescribed range (e.g., a range where the face direction thereof can be regarded as the front with respect to the direction of travel of the vehicle 2) and the difference from the face direction of the driver in the immediately preceding image is below a prescribed threshold (within a range where the face direction thereof can be estimated to remain roughly unchanged) is decided.

When the control unit 12 decides that the face direction of the driver cannot be estimated to remain unchanged, that is, it decides that the face is moving to a certain extent or more in step S4, the processing is finished. On the other hand, when it decides that the face direction of the driver can be estimated to remain unchanged, the operation goes to step S5.

In step S5, the control unit 12 decides whether the vehicle 2 is in the specified traveling condition and the state where the face direction of the driver can be estimated to remain unchanged has continued for a prescribed period of time. When it decides that the state where the face direction of the driver can be estimated to remain unchanged has continued for the prescribed period of time in step S5, the operation goes to step S6. On the other hand, when it decides that the state has not continued for the prescribed period of time, the processing is finished. Whether the state has continued for the prescribed period of time may be decided, for example, by counting the period of time from the detection of an image showing the state where the face direction of the driver can be estimated to remain unchanged so as to decide whether the prescribed period of time (e.g., around 10 seconds) elapsed with the state being kept. Or by counting the number of frames of the images showing the state where the face direction of the driver can be estimated to remain unchanged, whether the prescribed number of frames (e.g., the number of frames which can be acquired in around 10 seconds) of the images showing the state were acquired may be decided.

In step S6, the control unit 12 determines a reference of the face direction of the driver, and then, the operation goes to step S7. Specifically, information concerning the face direction of the driver in each of images acquired in the prescribed period of time is read from the face direction storing part 13b, and using the information concerning the face direction of the driver in each of the images, the reference is determined. As a way to determine the reference of the face direction, the mean value of the face direction of the driver in each of the images may be used as a reference value, or the most frequent value of the face direction of the driver in each of the images may be used as a reference value. The reference of the face direction of the driver may be the mean value of angle information showing the face direction of the driver, for example, angle information of at least one of the yaw angle, pitch angle and roll angle, or may be the most frequent value thereof. Or the mean value or most frequent value concerning the position of each organ of the face may be included.

In step S7, the control unit 12 stores information concerning the reference of the face direction determined in step S6 in the reference storing part 13d, and then, the processing is finished. In the reference storing part 13d, as well as the reference (the reference value) of the face direction, additional information such as date and time data, and driving circumstances data (such as outside illuminance data) may be stored.

In another embodiment, the control unit 12 may be allowed to have an identifying part (not shown) for identifying a driver, so as to determine a reference of the face direction for each driver identified by the identifying part. The identifying part may identify the driver by face identification processing using an image, or set or select the driver through an operating part such as a switch.

For example, in the detection of the face direction in the above step S 1, the control unit 12 detects a face of a driver in an image (step S12), and thereafter, conducts face identification processing of the driver, so as to judge whether he/she is a new driver or a registered driver. In the case of a new driver, the processing in steps S2-S6 is conducted, and in step S7, information concerning the reference of the face direction, as well as the face identification information of the driver, are stored in the reference storing part 13d. On the other hand, in the case of a registered driver, the processing may be finished, since the reference of the face direction has been stored in the reference storing part 13d.

In the reference storing part 13d, one reference of the face direction or a plurality of references of the face direction for one driver may be stored. For example, according to the traveling speed range (an intermediate speed range, a high speed range) of the vehicle 2, the reference of the face direction in each speed range may be determined and stored. Or according to on/off of the head lights of the vehicle 2 (day and night), the reference of the face direction in each case may be determined and stored. According to the traveling condition of the vehicle 2 where the face direction of the driver looking forward is estimated to slightly change like these, the reference of the face direction in each case may be determined and stored.

The processing of grasping (monitoring) the driver state conducted by the control unit 12 in the information processing apparatus 10 is described below.

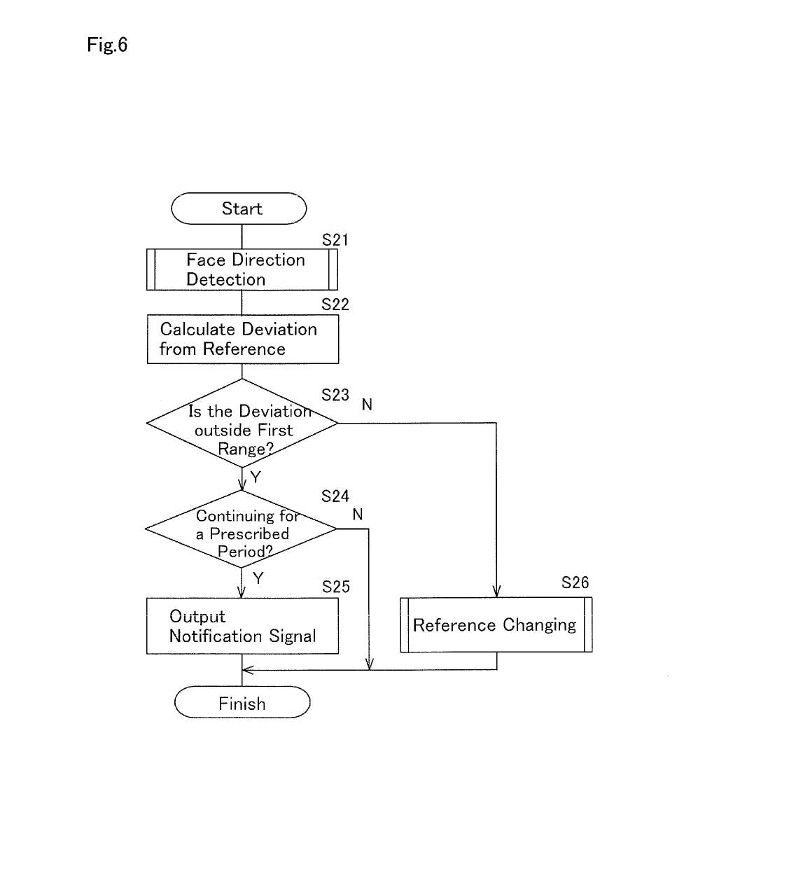

FIG. 6 is a flowchart showing an example of processing operations of driver monitoring conducted by the control unit 12 in the information processing apparatus 10 according to the embodiment. By the camera 20, a prescribed number of frames of images are picked up every second. The control unit 12 captures these picked-up images chronologically, and may conduct this processing on every frame or each frame at established intervals.

In step S21, the control unit 12 detects the face direction of a driver. The detection of the face direction of the driver may be similar to that in steps S11-S15 shown in FIG. 5, and it is not explained here.

After the detection of the face direction of the driver in step S21, the operation goes to step S22. In step S22, the control unit 12 reads the reference of the face direction from the reference storing part 13d, and calculates the difference between the face direction of the driver detected in step S21 and the reference of the face direction (e.g., a deviation from the reference value). Then, the operation goes to step S23.

The reference of the face direction includes, for example, at least one of the yaw angle, pitch angle and roll angle as reference values. The angle differences between these reference values and the face direction of the driver detected in step S21 (at least one of the yaw angle, pitch angle and roll angle) are computed, and the computed angle differences may be deviations from the reference values.

When a plurality of references of the face direction according to the traveling condition of the vehicle 2 are stored in the reference storing part 13d, after conducting the detection of the face direction in step S21, in place of step S22, the processing wherein vehicle information is acquired, the traveling condition of the vehicle 2 is decided, the reference of the face direction corresponding to the decided traveling condition is read from the reference storing part 13d, and the deviation from the reference of the face direction is calculated, may be conducted.

In step S23, the control unit 12 decides whether the deviation from the reference value (e.g., the angle difference of at least one of the yaw angle, pitch angle and roll angle) calculated in step S22 is above a first range (such as a prescribed angle difference).

The first range can be selected variously according to the aim of monitoring. For example, in the case of deciding the looking-aside state, as the first range (looking-aside decision angles), a prescribed angle range including at least the horizontal direction (yaw angle) may be selected.

In the case of deciding the degree of concentration on driving or fatigue (including sleepiness, etc.), as the first range (concentration/fatigue degree decision angles), a prescribed angle range including at least the vertical direction (pitch angle) may be selected.

In the case of deciding whether the driver's attitude allows the switching from the automatic operation mode to the manual operation mode, as the first range (transfer decision angles), a prescribed angle range including at least the horizontal direction (yaw angle) and the vertical direction (pitch angle) may be selected.

When it is judged that the deviation from the reference value is above the first range in step S23, the operation goes to step S24. In step S24, the control unit 12 decides whether the state of being above the first range has continued for a prescribed period of time. As the prescribed period of time, an appropriate period of time (time or the number of frames of the images may be counted) according to the aim of monitoring may be selected.

When it is judged that the state of being above the first range has not continued for the prescribed period of time in step S24, the processing is finished. On the other hand, when it is judged that the state has continued for the prescribed period of time, the operation goes to step S25.

In step S25, the control unit 12 outputs a notification signal to the notifying device 37, and thereafter, the processing is finished. The notification signal is a signal for allowing the notifying device 37 to conduct notification processing according to the aim of monitoring.

The notifying device 37 conducts prescribed notification processing on the basis of the notification signal from the information processing apparatus 10. The notification processing may be conducted by sound or voice, by light, by display, or by vibration of the steering wheel 52 or the seat. Various notification modes are applicable.

When the aim of monitoring is to decide the looking-aside state, for example, notification for letting the driver know that he/she is in the looking-aside state, or urging the driver to stop looking aside and direct his/her face to the front may be conducted. Or when the aim of monitoring is to decide the degree of concentration on driving or fatigue, for example, the driver may be notified of the reduced degree of concentration or the state of high degree of fatigue. Or when the aim of monitoring is a decision to permit the switching from the automatic operation mode to the manual operation mode, for example, notification for urging the driver to take an appropriate driving attitude may be conducted.

The processing operations in steps S23, S24, and S25 are not essential, and the processing of storing the information concerning the deviation from the reference value calculated in step S22 in the storage unit 13 may replace.

Instead of the processing in step S25, processing of storing the decision information in steps S23 and S24 (the information showing that the deviation is outside the first range and that the state has continued for the prescribed period of time, and the information concerning the face direction at that time) in the storage unit 13 may be conducted. Or instead of the processing in step S25, the decision information in steps S23 and S24 may be output to the automatic operation control device 30.

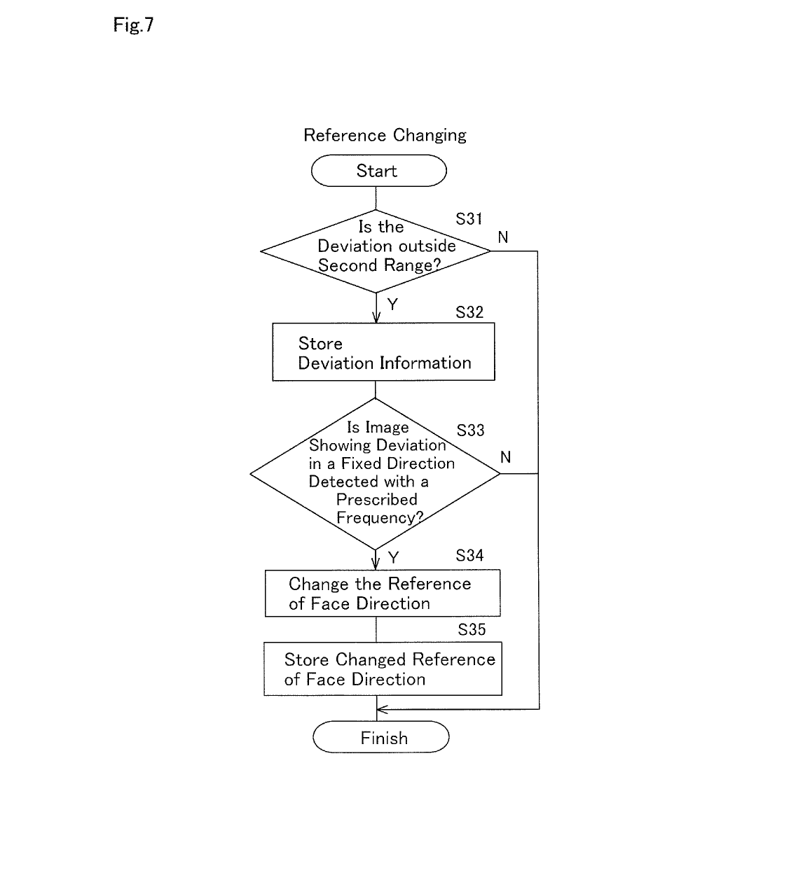

When it is judged that the deviation from the reference value is not above the first range in step S23, the operation goes to the changing of the reference value in step S26. The changing of the reference value in step S26 is explained below by reference to a flowchart shown in FIG. 7. The changing of the reference value in step S26 is not essential, and in another embodiment, without conducting the changing of the reference value, the processing may be finished.

FIG. 7 is a flowchart showing an example of processing operations of reference value changing conducted by the control unit 12 in the information processing apparatus 10 according to the embodiment.

In step S31, the control unit 12 judges whether the deviation from the reference (the reference value) of the face direction calculated in step S22 is above the second range of regarding as facing in the direction represented by the reference value (to the front) (whether it is outside the second range). The second range may include angle range information of at least one of the yaw angle, pitch angle and roll angle which show the face direction. And the second range is a smaller angle range than the first range, and may be set to be, for example, the angle range of ±5° from the reference of the face direction.

When it is judged that the deviation from the reference (the reference value) of the face direction is not above the second range, in other words, the face of the driver is directed to the direction represented by the reference value (the direction regarded as the front) in step S31, the processing is finished. On the other hand, when it is judged that the deviation from the reference (the reference value) of the face direction is above the second range (the face direction of the driver is a little deviated from the direction regarded as the front) in step S31, the operation goes to step S32.

In step S32, the control unit 12 associates the information showing the deviation from the reference value calculated in step S23 (i.e., deviation information showing that the deviation is within the first range and above the second range) with the detection information of the face direction in the image concerned, and stores them in the face direction storing part 13b. Then, the operation goes to step S33. In another embodiment, before step S32, whether the vehicle 2 is in a specified traveling condition may be judged (the same processing in step S3 in FIG. 4 may be conducted), and when it is in the specified traveling condition, the operation may go to step S32. By this construction, it becomes possible to make the condition for changing the reference value fixed.

In step S33, the control unit 12 reads the detection information of the face direction in the image associated with the deviation information from the face direction storing part 13b, and judges whether the image showing a direction with a fixed deviation from the reference value (almost the same direction) was detected with a prescribed frequency (or at a prescribed rate). That is, whether the state where the face direction of the driver is just slightly different in a fixed direction from the front indicated by the reference value (the state where it is not different to such an extent as to be regarded as a looking-aside state) has frequently occurred is judged.

When it is judged that the image showing the direction with the fixed deviation from the reference value has not been detected with the prescribed frequency in step S33, the processing is finished. On the other hand, when it is judged that it was detected with the prescribed frequency, the operation goes to step S34.

In step S34, the control unit 12 changes the reference of the face direction. For example, in order to make it easier to judge that the state of the face direction different in the fixed direction is the front of the face direction of the driver, the reference value is changed, and the operation goes to step S35. Specifically, when the deviation of the face direction from the reference value was about 3° downward, for example, the reference value of the face direction is changed by 3° downward, or changed so as to make it closer to 3° (make the deviation smaller).

In step S35, the control unit 12 stores the reference value changed in step S34 in the reference storing part 13d, and the processing is finished. By conducting such changing of the reference value, for example, even if the attitude of the driver changed due to long-time driving, changes in driving circumstances (changes in weather or time zone) and the like, so that the front direction of the face of the driver changed unconsciously, it is possible to set the front of the face of the driver in such state as the reference of the face direction, leading to an improvement in detection accuracy of the face direction.

### Operation/Effects

Using the information processing apparatus 10 according to the above embodiment, whether the vehicle 2 is in a specified traveling condition is decided by the first deciding part 12d, and a change in the face direction of the driver in the specified traveling condition is decided by the second deciding part 12e. And on the basis of the face direction of the driver while the face direction of the driver is decided to remain unchanged, the reference of the face direction of the driver is determined by the reference determining part 12f, and using the reference of the face direction, the face direction of the driver is calculated by the calculating part 12g.

Accordingly, the reference of the face direction according to the individual difference in the face direction of the driver can be determined, and using the reference of the face direction, without processing burden on the control unit 12, it is possible to improve the detection accuracy of the face direction of the driver.

Since by reading the reference of the face direction from the reference storing part 13d, the face direction of the driver can be calculated, the processing burden for determining the reference of the face direction by the reference determining part 12f can be reduced. On the basis of the face direction calculated by the calculating part 12f, the processing part 12h can conduct various kinds of processing. Since the reference of the face direction determined by the reference determining part 12f can be changed by the reference changing part 12i, the reference can be kept appropriate, and the face direction can be always detected with high accuracy.

Using the driver monitoring system 1 according to the above embodiment, having the information processing apparatus 10 and the camera 20, it is possible to realize at a low cost a driver monitoring system by which various kinds of effects of the information processing apparatus 10 can be obtained. In the above embodiment, the case where the driver monitoring system 1 was applied to the vehicle 2 was explained, but it may be applied to means of transportation other than the vehicle.

The embodiment of the present invention was explained above in detail, but the above explanations are merely examples of the present invention in every point. It is needless to say that it is possible to conduct various kinds of modifications or changes without going out of scope of the present invention.

For example, in the above embodiment, the face direction of the driver is detected, but the information processing apparatus may detect a direction of the visual line of the driver in place of the face direction thereof, or as well as the face direction thereof, determine a reference of the direction of the visual line, and calculate the direction of the visual line of the driver using the reference thereof.

### Additions

The embodiment of the present invention can also be described like the below-described additions, but it is not limited to those.

### (Addition 1)

An information processing apparatus (10), comprising:
an image acquiring part (12a) for acquiring an image (21) including a face of a driver (D) of a vehicle (2);
a detecting part (12b) for detecting a face direction of the driver (D) in the image (21) acquired by the image acquiring part (12a);
an information acquiring part (12c) for acquiring information concerning a traveling condition of the vehicle (2);
a first deciding part (12d) for deciding whether the vehicle (2) is in a specified traveling condition, on the basis of the information acquired by the information acquiring part (12c); and
a reference determining part (12f) for determining a reference of the face direction of the driver (D), on the basis of the face direction of the driver (D) while the vehicle (2) is decided to be in the specified traveling condition by the first deciding part (12d).

### (Addition 2)

A driver monitoring system (1), comprising:
an information processing apparatus (10); and
at least one camera (20) for picking up an image (21) including a face of a driver (D) acquired by an image acquiring part (12a).

### (Addition 3)

An information processing method, conducting the steps of:
image acquisition (S11) for acquiring an image (21) including a face of a driver (D) of a vehicle (2);
detection (S14) for detecting a face direction of the driver (D) in the image (21) acquired in the step of image acquisition (S11);
information acquisition (S2) for acquiring information concerning a traveling condition of the vehicle (2);
decision (S3) for deciding whether the vehicle (2) is in a specified traveling condition, on the basis of the information acquired in the step of information acquisition (S2); and
   reference determination (S6) for determining a reference of the face direction of the driver (D), on the basis of the face direction of the driver (D) while the vehicle (2) is decided to be in the specified traveling condition in the step of decision (S3).

### (Addition 4)

A computer-readable storage medium (13) in which computer programs have been stored, the programs for allowing at least one computer (12) to conduct the steps of:
image acquisition (S11) for acquiring an image (21) including a face of a driver (D) of a vehicle (2);
detection (S14) for detecting a face direction of the driver (D) in the image (21) acquired in the step of image acquisition (S11);
information acquisition (S2) for acquiring information concerning a traveling condition of the vehicle (2);
decision (S3) for deciding whether the vehicle (2) is in a specified traveling condition, on the basis of the information acquired in the step of information acquisition (S2); and
reference determination (S6) for determining a reference of the face direction of the driver (D), on the basis of the face direction of the driver (D) while the vehicle (2) is decided to be in the specified traveling condition in the step of decision (S3).

What is claimed is:

1. An information processing apparatus, comprising:
an image acquiring part for acquiring an image including a face of a driver of a vehicle;
a detecting part for detecting a face direction of the driver in the image acquired by the image acquiring part;
an information acquiring part for acquiring information concerning a traveling condition of the vehicle;
a first deciding part for deciding whether the vehicle is in a specified traveling condition, on the basis of the information acquired by the information acquiring part; and
a reference determining part for determining a reference of the face direction of the driver, on the basis of the face direction of the driver while the vehicle is decided to be in the specified traveling condition by the first deciding part.

2. The information processing apparatus according to claim 1, further comprising a second deciding part for deciding a change in the face direction of the driver while the vehicle is decided to be in the specified traveling condition by the first deciding part, wherein
the reference determining part determines the reference, on the basis of the face direction of the driver while the face direction of the driver is decided to remain unchanged by the second deciding part.

3. The information processing apparatus according to claim 1, further comprising a calculating part for calculating the face direction of the driver with respect to the reference from the image, using the reference determined by the reference determining part.

4. The information processing apparatus according to claim 3, further comprising a processing part for conducting prescribed processing, on the basis of the face direction of the driver with respect to the reference calculated by the calculating part.

5. The information processing apparatus according to claim 4, further comprising a notifying part for notifying the driver of a result processed by the processing part.

6. The information processing apparatus according to claim 3, further comprising a reference storing part for storing the reference determined by the reference determining part, wherein
the calculating part calculates the face direction of the driver with respect to the reference from the image, using the reference read from the reference storing part.

7. The information processing apparatus according to claim 3, further comprising a reference changing part for changing the reference determined by the reference determining part.

8. The information processing apparatus according to claim 7, wherein
the reference changing part corrects the reference so as to reduce a difference between the face direction of the driver with respect to the reference calculated by the calculating part and the reference, when the difference therebetween has been held within a prescribed range.

9. The information processing apparatus according to claim 1, wherein the specified traveling condition is a traveling condition where the vehicle is going straight forward.

10. The information processing apparatus according to claim 1, wherein
the information acquiring part acquires at least speed information of the vehicle and steering information of the vehicle, and
the first deciding part decides that the vehicle is in the specified traveling condition, when the speed of the vehicle is within a prescribed speed range and the vehicle is in a prescribed non-steering state.

11. The information processing apparatus according to claim 1, wherein
the information acquiring part acquires at least one of acceleration/deceleration information of the vehicle and inclination information of the vehicle, and
the first deciding part excepts a case where the vehicle is in a prescribed state of acceleration or deceleration, or a case where the vehicle is in a prescribed inclined position from the specified traveling condition.

12. The information processing apparatus according to claim 1, wherein
the information acquiring part acquires position information of the vehicle and map information of the periphery of the vehicle, and
the first deciding part decides that the vehicle is in the specified traveling condition when the vehicle is moving on a straight-line road.

13. The information processing apparatus according to claim 1, further comprising an identifying part for identifying the driver, wherein
the reference determining part determines the reference for each driver identified by the identifying part.

14. A driver monitoring system, comprising:
the information processing apparatus according to claim 1; and
at least one camera for picking up an image including the face of the driver acquired by the image acquiring part.

15. An information processing method, comprising the steps of:
acquiring an image including a face of a driver of a vehicle;
detecting a face direction of the driver in the image acquired in the image acquisition step;
acquiring information concerning a traveling condition of the vehicle;
deciding whether the vehicle is in a specified traveling condition, on the basis of the information acquired in the information acquisition step; and
determining a reference of the face direction of the driver, on the basis of the face direction of the driver while the vehicle is decided to be in the specified traveling condition in the decision step.

16. A computer-readable storage medium in which computer programs have been stored, the programs for allowing at least one computer to conduct the steps of:
acquiring an image including a face of a driver of a vehicle;
detecting a face direction of the driver in the image acquired in the image acquisition step;
acquiring information concerning a traveling condition of the vehicle;
deciding whether the vehicle is in a specified traveling condition, on the basis of the information acquired in the information acquisition step; and
determining a reference of the face direction of the driver, on the basis of the face direction of the driver while the vehicle is decided to be in the specified traveling condition in the decision step.
